(19) United States
(12) Patent Application Publication
(10) Pub. No.: US 2005/0166206 A1
(43) Pub. Date: Jul. 28, 2005

(54) Resource management in a processor-based system using hardware queues

(76) Inventor: Dale E. Parson, Rockland Township, PA (US)

Correspondence Address: Ryan, Mason & Lewis, LLP, Suite 205, 1300 Post Road, Fairfield, CT, 06824, US

(21) Appl. No.: 10/764,967

(22) Filed: Jan. 26, 2004

(51) Int. Cl. G06F 9/46

(52) U.S. Cl. 718/104

(57) ABSTRACT

In a processor-based system, a number of data values are stored in a hardware queue. Each data value is associated with a corresponding one of a number of resources. Presence of a given one of the data values in the hardware queue indicates availability of its corresponding resource to a requesting object. The given data value from the hardware queue is used to access the corresponding resource. Reading a data value from the hardware queue removes the data value from the hardware queue, and therefore a particular resource is removed from a “pool” of resources and is allocated to a requesting object in the processor-based system. Other objects in the processor-based system can no longer access this particular resource. Similarly, writing a data value to the hardware queue adds the data value to the hardware queue, and therefore a particular resource is added to the pool of resources and is recovered because all objects in the processor-based system can again access the particular resource (e.g., by accessing the hardware queue and retrieving the data value corresponding to the particular resource).

### FIELD OF THE INVENTION

The present invention relates generally to multithreaded processors and other processor-based electronic systems, and more particularly, to resource management in such systems.

### BACKGROUND OF THE INVENTION

In the multithreaded processor context, the term “mutex” is short for “mutual exclusion” and commonly refers to a device that allows multiple threads to synchronize access to a resource. Mutexes are typically implemented as software or hardware mutexes, and a mutex has two states: locked and unlocked. Once a mutex has been locked by a thread, other execution threads attempting to lock it will block, meaning that the other threads have to wait until the mutex is unlocked. After the locking thread unlocks the mutex, one of the blocked threads will typically acquire the mutex by locking the mutex. Mutexes are beneficial for synchronizing access to resources, but mutexes also introduce some problems.

For instance, most processor architectures suffer from the fact that allocation and recovery of resources typically require execution of multiple instructions, which can impact performance. As a more specific example, multithreaded processors, such as a network processor, incur additional costs in time and power because threads must loop on software mutexes to gain access to a “pool” of resources that is shared by all threads. A thread typically will poll the software mutex, and polling of the mutex uses the memory bus. In a typical network processor, for example, a test-and-set bit can be implemented via an atomic test-and-set instruction accessing memory. In such a case, threads looping on such a bit cause noise on buses to memory while querying the test-and-set bit in a loop, delaying other accesses by other threads to the buses and consuming power. This causes thread synchronization overhead problems of memory bandwidth and increased power consumption. Repeated looping for the purpose of polling a mutex to lock the mutex is typically called a “spin lock.” During the spin lock, other threads are effectively stalled, which causes a performance loss through, e.g., time delays. Furthermore, spin locks cause performance loss through temporal indeterminacies, as a thread polling a software mutex cannot determine in advance when the thread will be granted a mutex.

Resource pools can be maintained using software multithreading, using a combination of scheduling and mutex-related system calls to avoid a critical section problem (i.e., simultaneous access to shared data by multiple threads). The costs of maintaining resource pools using software are much greater for a multithreaded processor than for a non-multithreaded processor, because a multithreaded processor must execute the instructions for reads from or writes to the resource pool atomically in order to avoid interference between threads. As previously described, multiple threads must therefore wait when contending for shared data.

One potential solution to these problems is a hardware mutex. A hardware mutex is implemented so that a thread requesting a locked mutex is shut down until the mutex is unlocked and available for use by the thread. Thus, hardware mutexes avoid spin locks, but the hardware mutexes can cause stalls in threads waiting for a mutex.

Consequently, there are two important problems in the area of resource allocation and recovery: 1) performance loss through time delays and temporal indeterminacies in resource allocation and recovery for processor-based systems generally; and 2) thread synchronization overhead (e.g., time required to receive a mutex and coordinate mutex use by threads, and increased power consumption) in multithreaded processor-based systems.

A need therefore exists for techniques that provide faster allocation and recovery of resources while decreasing or eliminating the aforementioned problems.

### SUMMARY OF THE INVENTION

Generally, techniques for processor-based resource management using hardware queues are described.

In an exemplary aspect of the invention, in a processor-based system, a number of data values are stored in a hardware queue. Each data value is associated with a corresponding one of a number of resources. Presence of a given one of the data values in the hardware queue indicates availability of its corresponding resource to a requesting object. The given data value from the hardware queue is used to access the corresponding resource.

Resources will generally be managed by allocating or recovering the resources, and this management is at least partially performed by reading data values from the hardware queue or by writing data values to the hardware queue, respectively. For instance, reading a data value from the hardware queue removes the data value from the hardware queue, and therefore a particular resource is removed from a “pool” of resources and is allocated to a requesting object in the processor-based system. Illustratively, other objects in the processor-based system can no longer access this particular resource. Similarly, writing a data value to the hardware queue adds the data value to the hardware queue, and therefore a particular resource is added to the pool of resources and is recovered because all objects in the processor-based system can again access the particular resource (e.g., by accessing the hardware queue and retrieving the data value corresponding to the particular resource).

Typically, the hardware queue will be a First-In, First-Out (FIFO) device. However, other devices such as a Last-In, Last-Out (LIFO) device or a double-ended queue device (e.g., where data values can be written to or read from each “side” of a memory in the double-ended queue) may be used.

As described above, the data values stored in the hardware queue correspond to resources. Exemplary resources that can be managed by the present invention include, but are not limited to, the following: memory address ranges that correspond to indexes into memory; local storage memory locations that correspond to hardware thread identifications; connection identifiers such as Transmission Control Protocol (TCP)/Internet Protocol (IP) or User Datagram Protocol (UDP)/IP ports for Network Address Port Translation (NAPT), where the ports correspond to integers identifying the ports; and portions (e.g., rows) of a connection status table, where the portions correspond to indexes.

### BRIEF DESCRIPTION OF THE DRAWINGS

FIG. 1 is a block diagram of a prior art system using hardware First-In, First-Out (FIFO) devices (FIFOs);

FIG. 2 is a block diagram of an exemplary computer system providing resource management using a hardware queue in accordance with an exemplary embodiment of the present invention; FIG. 3 is an exemplary table for address resource mapping, for which data values corresponding to portions of the table could reside in the hardware queue shown in the system of FIG. 2 and be used to manage memory in accordance with the table;

FIG. 4 is an exemplary table for storing connection status for TCP connection state, for which data values corresponding to the table could reside in the hardware queue shown in the system of FIG. 2 and be mapped to portions of the table to manage table entries of the table;

FIG. 5A is an exemplary table for mapping integers to ephemeral TCP or UDP ports for Network Address Port Translation (NAPT), for which data values corresponding to the table could reside in the hardware queue shown in the system of FIG. 2 and be used to manage TCP or UDP ports;

FIG. 5B is the exemplary table of FIG. 5A shown after TCP/UDP ports have been recovered in FIFO order; and

FIG. 6 shows an exemplary circular buffer implementation and internal memory for a FIFO.

### DETAILED DESCRIPTION

The present invention in an illustrative embodiment can support single-instruction-cycle management of resources, such as rows in a state table or TCP/UDP port numbers in a real-time application such as stateful network processing. Management of resources includes allocation of resources and recovery of the resources. A resource is any item that can be shared by objects in a processor-based system. The objects could be, for instance, applications, threads, operating systems or portions thereof. For simplicity, it is assumed in the following description that a thread is the object managing resources, but this assumption is for expository purposes only.

In accordance with one exemplary aspect of the present invention, a hardware queue is provided that can be used to store data values, which correspond to resources. The data values are used to access resources corresponding to the data values. The hardware queue can support single-instruction-cycle allocation and recovery of resources by allowing single-instruction-cycle reading of data values from and writing of data values into the hardware queue. If a data value is taken out of the hardware queue by a particular thread, the resource corresponding to that data value is no longer available for use by other threads. Similarly, if a data value is placed back into the hardware queue by a particular thread, the resource corresponding to that data value is available for use by any thread.

Typically, the resources are integer-keyed, meaning that the data values stored in the hardware queue are integers corresponding to resources and can be mapped to those resources. However, integers are not a requirement, and any string of binary digits able to correspond to a resource is suitable for use with the present invention. The present invention can also be made to support arbitration among multiple threads for access to resources without requiring software spin locks, which are costly in terms of time and bus contention, or hardware mutexes, which can stall hardware threads, causing delays. This is explained in more detail below.

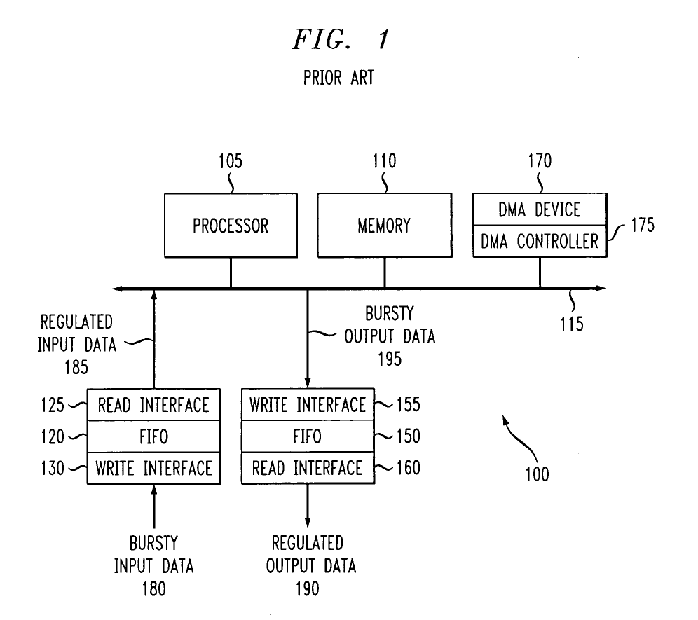

Conventional hardware FIFOs have typically been applied to buffering bursts in data streams that are input to a processor or output from a processor. For instance, see “FIFO Architecture, Functions, and Applications,” Texas Instruments (1999), the disclosure of which is hereby incorporated by reference. FIG. 1 shows two conventional uses of hardware FIFOs in a computer system 100. A non-multithreaded or multithreaded processor 105, a memory 110, a read interface 125 of an input-buffering FIFO 120, a write interface 155 of an output-buffering FIFO 150 and a Direct Memory Access (DMA) controller 175 of a DMA device 170 all couple to a high-speed data bus 115 controlled by the processor 105. The input-buffering FIFO 120 further comprises a write interface 130 that accepts bursty input data 180. The input-buffering FIFO 120 produces regulated input data 185. The output-buffering FIFO 150 also has a read interface 160. The output-buffering FIFO 150 accepts bursty output data 195 and produces regulated output data 190. Although not shown in FIG. 1, there will typically be an address bus and control bus for coupling to some or all of the components in computer system 100.

By way of example, the processor 105 can read one word of data from the input-buffering FIFO 120 by reading from the read interface 125 via the data bus 115. The processor 105 can write one word of data to the output-buffering FIFO 150 by writing to the write interface 155 via the data bus 115. If a DMA device 170 is used in the computer system 100, as in this example, the DMA device 170 can transfer, using a DMA controller 175, a block of data from the input-buffering FIFO 120 to memory 110 or from memory 110 to the output-buffering FIFO 150, interrupting the processor 105 to signal that the DMA transfer is complete. In the DMA case, the processor 105 would write or read memory buffers (not shown, but typically in memory 110) and allow the DMA controller 175 to manage data transfer between memory 110 and the FIFOs 120, 150. The DMA controller 175 is shown as being part of a DMA device 170, but the DMA controller 175 could be separate from the DMA device 170.

The purpose of the FIFOs 120, 150 in this conventional computer system 100 is to smooth bursts in speed in the arrival or departure of data 180, 190, respectively. On the input side (e.g., bursty input data 180), packets from a high-speed network (not shown) or an input data stream such as video data might arrive in bursts that are too fast for the processor 105 to process. While the average speed of arrival falls within the speed capacity of the processor 105, transient bursts of data may exceed this capacity. The input-buffering FIFO 120 smoothes a burst by accepting the incoming burst in FIFO order and buffering it until the processor 105 requests the buffered data at a rate suitable for the processor 105. Likewise, on the output side (e.g., bursty output data 195), if the processor 105 produces bursts of outgoing data for a network (not shown) or output device (not shown) such as a printer, the output-buffering FIFO 150 can accept the data bursts and buffer the data, which the outbound network or output device reads from the output FIFO at its own rate. Buffering bursts in input or output data streams is one of the primary commercial applications of hardware FIFOs, as described in “FIFO Architecture, Functions, and Applications,” Texas Instruments (1999), already incorporated by reference above.

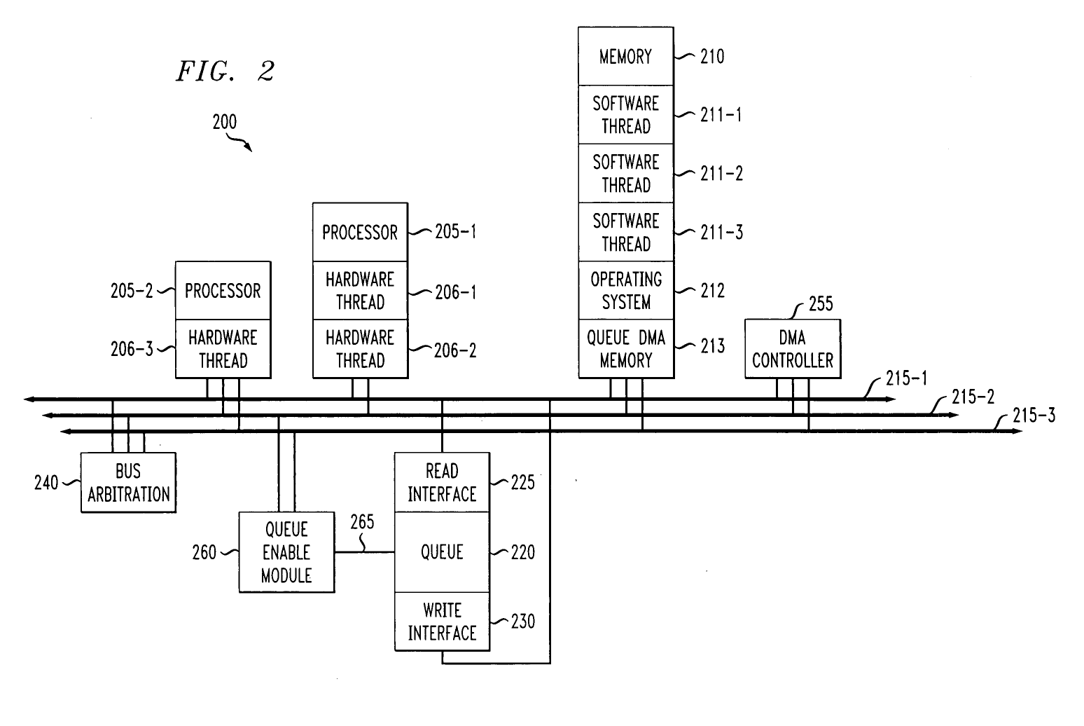

By contrast, the present invention uses a hardware queue (such as a FIFO or LIFO) that provides access to data values corresponding to and able to be mapped to resources and that is used to manage those resources. Turning now to FIG. 2, an exemplary computer system 200 is shown that provides resource management using a hardware queue in accordance with an exemplary embodiment of the present invention. Computer system 200 can be any type of system having one or more processors, such as a personal computer system, a network processor or a Personal Digital Assistant (PDA).

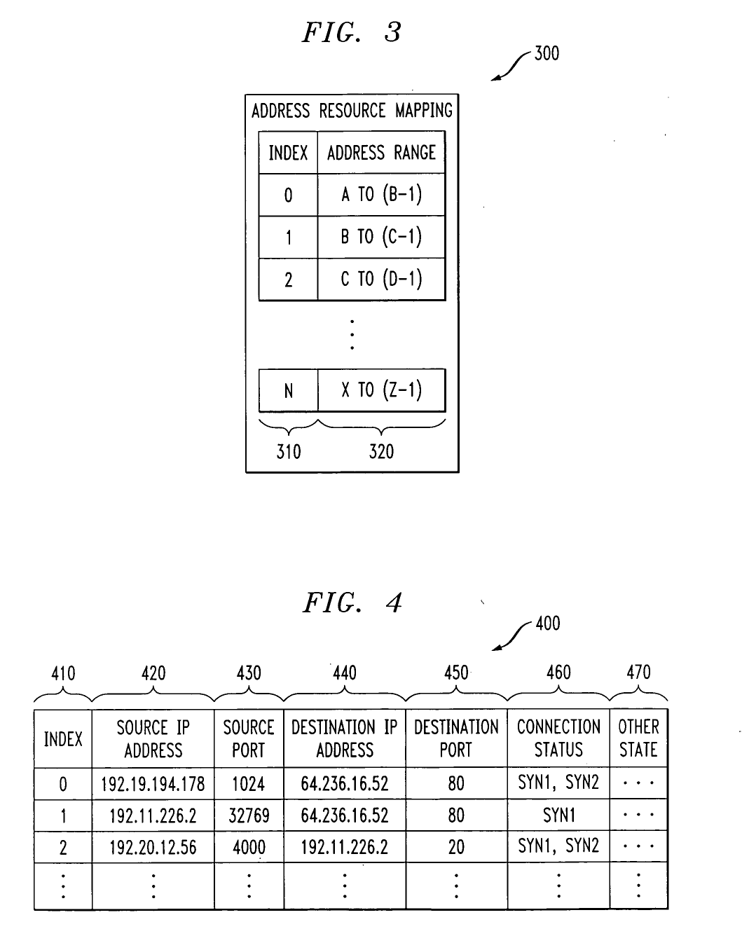

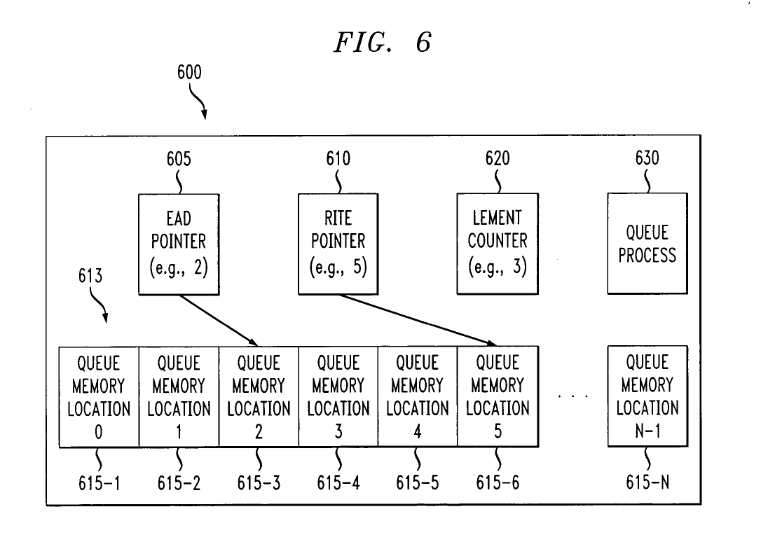

In this example, computer system 200 comprises two processors 205-1 and 205-2, memory 210, a DMA controller 255, a hardware queue 220, a queue enable module 260, a bus arbitration device 240, a data bus 215-1, an address bus 215-2, and a control bus 215-3. Processor 205-1 comprises hardware thread 206-1 and hardware thread 206-2, while processor 205-2 comprises hardware thread 206-3. Memory 210 comprises software threads 211-1 through 211-3, operating system 212, and queue DMA memory 213. Hardware queue 220 comprises a read interface 225 and a write interface 230. The hardware queue 220 typically comprises a queue process (not shown in FIG. 2 but shown in FIG. 6) and queue memory (not shown in FIG. 2 but shown in FIG. 6) used to store data values (not shown in FIG. 2 but shown in reference to FIGS. 3, 4, A and 5B).

The queue enable module 260 outputs one or more enable signals 265 used to enable the hardware queue 220 for reading or writing. The queue enable module 260 enables the hardware queue 220 when an address on the address bus 215-2 is equivalent to one or more addresses assigned to the hardware queue 220. Typically, the one or more enable signals 265 will be two enable signals 265, one for write enable, and one for a read enable. Additionally, there will generally be an address for the write interface 230, and another address for the read interface 225. FIG. 2 assumes a synchronous queue, such as a synchronous FIFO, but asynchronous queues may also be used. For an asynchronous queue, the queue enable device 260 would generally be a write enable or read enable or some other enable signal.

FIG. 2 shows exemplary use of a hardware queue 220 (such as a FIFO device or LIFO device) to provide resource management for applications such as those involving an address mapping resource table, state table, NAPT and its tables or a thread identification (ID) table, as will be further explained in the descriptions of FIGS. 3 through 6 below. Unlike the use of the FIFOs 120, 150 in FIG. 1, where a specific FIFO 120, 150 is configured either to supply input to a data bus 15 or to drain output from the data bus 1 , the hardware queue 220 of FIG. 2 is configured so that both its read interface 225 and write interface 230 are connected to the data bus 215-1 and accessible to a processor 205. Also unlike conventional FIFOs, the hardware queue 220 of FIG. 2 is not connected directly, on one side of the hardware queue 225, to an input or output peripheral or communications network. The configuration of FIG. 2 allows a processor 205 to write a data value to the hardware queue 220 within typically one instruction cycle, or to read a data value from hardware queue 220 typically within one instruction cycle.

In normal operation, one of the processors 205 would initialize the hardware queue 220 with data values that correspond to resources before application processing begins. Once the hardware queue 220 is initialized with data, the processors 205 can use the hardware queue 220 as a resource pool, allocating data values from the FIFO and returning data values to the FIFO in fixed time, typically within one instruction cycle. Because data values in the hardware queue 220 correspond to resources and the resources are managed through the hardware queue 220, the hardware queue 220 can be considered to be a pool of resources, as can the actual resources themselves. Generally, the sole technique for accessing a particular resource will be through the hardware queue 220. For instance, in a possible implementation of the present invention, the hardware queue 220 may be used to allocate memory locations from memory 210, and a processor 205 will read a data value from the hardware queue 220. The data value, as explained in reference to FIG. 3, can be used as an index to access a particular range of memory locations in memory 210. If there is no data value available from the hardware queue 220, then the processor 205 typically would not be able to allocate the resource, which in this example is one of a number of memory ranges.

In an exemplary embodiment, data values in the hardware queue 220 represent database keys associated with and mapped to application data. Examples of database keys are indexes into application memory data structures, network connection identifiers, and hardware resource identifiers. This embodiment and other exemplary embodiments are described in more detail below.

FIG. 2 also illustrates several additional concepts. For example, if both processors 205 attempt to access the hardware queue 220 at the same time, the bus arbitration device 240 will allow only one processor 205 to access the hardware queue 220 as per bus arbitration rules known to those skilled in the art. This provides automatic arbitration, without using hardware mutexes. Also, because arbitration acts to select one processor 205, there are no spin locks, although there may be a small time delay between when a processor 205 requests the data bus 215-1 and when the processor 205 is granted access to the data bus 215-1.

As another example, there are a number of different types of threads: hardware threads 206 and software threads 211. It should be noted that hardware threads 206 and software threads 211 are generally not implemented at the same time (e.g., as shown in FIG. 2), but such implementation is possible. Hardware threads 206, also called “contexts,” are generally supported explicitly by a processor 205. In the example of FIG. 2, the processor 205-1 contains hardware thread 206-1 and hardware thread 206-2. The processor 205-1 executes the hardware threads 206-1 and 206-2 through a memory (not shown) local to the processor 205-1. Similarly, the processor 205-2 contains and executes a hardware thread 206-3 through a memory (not shown) local to the processor 205-2. Hardware multithreading is implemented by having one program counter (not shown), stack pointer (not shown), and associated registers (not shown) for each thread 206 in each processor 205. Hardware multithreading supports genuine concurrent execution of hardware threads.

By contrast, software multithreading is implemented by having a single program counter, stack pointer, and associated registers in each processor 205, and by retrieving, using, then storing these registers from memory 210 and software threads 211. Only one software thread 211 uses the hardware registers at a given time in software multithreading. Software multithreading gives the appearance that multiple software threads 211 are running per processor 205, but in reality only one software thread 211 is executed per processor 205.

As described above, one technique used for mutex locking and unlocking involves hardware mutexes. In one hardware mutex technique, a hardware thread requests a hardware mutex. A device examines a lock bit corresponding to the hardware mutex to determine if the mutex is locked. If the mutex is locked, the device physically stops the hardware thread and places a thread identification (ID) into a queue. When the mutex is unlocked and the thread is selected from the queue, the device will restart the hardware thread. Thus, the hardware thread is disabled for some period of time while the mutex is locked. Moreover, the hardware thread does not access the queue; instead, the device does. Additionally, the queue for a hardware mutex implementation holds thread IDs. By contrast, in the present invention, the hardware queue 220 holds data values corresponding to resources and there should be very little time between when a hardware thread requests a data value from the hardware queue 220 and when the hardware thread receives the data value. Furthermore, the data values will be mapped to their corresponding resources, generally by an application, thread or operating system.

Typically, a processor 205 accesses the hardware queue 220 in order to provide resource management. The processor 205 will perform accesses to the hardware queue 220 generally by executing statements from a hardware thread 206, a software thread 211, the operating system 212, or other software.

Additionally, the hardware queue 220 could also be written or read via memory buffers used by a processor 205. For example, the queue DMA memory 213 of memory 210 could be used as a buffer between a processor 205 and the hardware queue 220. A processor 205 could inform the DMA controller 255 to transfer a number of data values from the hardware queue 220 to the queue DMA memory 213. The DMA controller 255 would inform the processor once the data values were transferred and the processor 205 would then retrieve one or more of the data values from the queue DMA memory 213. Alternatively, the processor 205 could write a number of data values into the queue DMA memory 213 and inform the DMA controller 255 to transfer the data values from the DMA memory 213 into the hardware queue 220. The data values would then be transferred to the hardware queue 220 by the DMA controller 255, and the DMA controller 255 would inform the processor 205 when the transfer was complete.

The techniques discussed herein may be at least partially implemented as an article of manufacture comprising a machine-readable medium, as part of memory 210 for example, containing one or more programs which when executed by one or more processors 205 implement embodiments of the present invention. For instance, the machine-readable medium may contain a program configured to access the hardware queue 220 in order to manage a resource. The machine-readable medium may be, for instance, a recordable medium such as a hard drive, an optical or magnetic disk, an electronic memory, or other storage device.

It should be noted that some computer systems 200 do not have an operating system 212. For example, some network processors do not have an operating system 212.

It should also be noted that there are conventional devices having two separate memories and two complete FIFOs, one of which typically buffers incoming data and the other of which typically buffers outgoing data. In other words, FIFOs 120 and 150 of FIG. 1 would be placed in a single package and have multiple memories corresponding to each FIFO 120, 150. However, in the present invention, the read interface 225 and write interface 230 are to a single queue memory (shown in FIG. 6 for a FIFO implementation of a hardware queue 220), and a processor 205 can read to or write from the single queue memory using the read interface 225 and write interface 230, respectively.

Additionally, the hardware queue 220, processors 205 and memory 210 can reside on the same semiconductor or reside on different semiconductors coupled together through a circuit board.

The hardware queue 220 of FIG. 2 is suitable for any resource able to correspond to a data value storable in the hardware queue 220. FIGS. 3, 4, A and B provide examples of the types of resources able to be managed using implementations of the hardware queue 220.

Turning now to FIG. 3, an exemplary table 300 for address resource mapping is shown. Data values corresponding to the table 300 could reside in the hardware queue 220 shown in the system of FIG. 2. The table 300 comprises indexes 310 and address ranges 320. Indexes 310 are usually the data values stored in hardware queue 220. Generally, when a thread executes, the thread is allocated one or more blocks of memory locations in memory 210. A portion of memory 210 is generally divided into a number of blocks, where each block is the same size. Although the memory blocks need not be the same size, use of same-size memory blocks simplifies memory management.

Table 300 shows indexes 310, from zero through N, and an address range 320 to which the indexes 310 correspond. An index 310 of zero, for example, corresponds to the address range 320 of A to (B-1), while an index 310 of one corresponds to the address range 320 of B to (C-1). As described above, the ranges are generally the same size, so the difference between (B-1) and A and the difference between (C-1) and B will be the same. In this example, the indexes 310 are integers and each integer corresponds to an address range 320. A thread, such as a hardware thread 206 or software thread 211, could make a request (e.g., a request for allocation of memory for a database or the startup of the thread) for memory. Generally, a thread processes the request for memory and will request, e.g., via instructions corresponding to the thread and loaded into a processor 205, access to the hardware queue 220. The indexes 310 are stored in the hardware queue 220. The thread receives the index 310 from the hardware queue 220, maps the index 310 to an appropriate address range 320, and allocates the address range 320 corresponding to the value of the index 310. One technique for mapping the address range 320 is to multiply the index 310 by a number equivalent to a size of a block of memory and to add the result of the multiplication to an offset (if any). The resource of a particular address range 320 is recovered when a thread (e.g., or the operating system 212) writes an integer corresponding to particular address range 320 into the hardware queue 220. Once the integer is written to the hardware queue 220, memory corresponding to the integer is effectively deallocated, although additional steps might be used for deallocation of the memory. Address mapping and memory management are known to those skilled in the art.

Referring now to FIG. 4, this figure shows an exemplary table 400 for storing connection status for TCP connection state. Data values corresponding to the table 400 could reside in the hardware queue 220 shown in the system of FIG. 2. Table 400 shows a multiple-row state table (also called a “database”) that resides in a memory 210 or could reside in a cache memory (not shown in FIG. 2) of a processor 205. Each row (e.g., of which indexes 410 of 0, 1, and 2 are shown) comprises an index 410, a source Internet Protocol (IP) address 420, a source port 430, a destination IP address 440, a destination port 450, a connection status 460, and other state 470. Each row is conceptually equivalent to a C language “struct” in the C (or C++) programming language, and the entire table 400 is equivalent to an array of these “structs.” A real-time application, e.g., comprising one or more threads, would typically allocate the entire table 400 at initialization time, but the application would need to allocate rows within the table 400 as the application executes, for example as new TCP connections are made, and recover rows as the application executes, for example as TCP connections are terminated. The first sequence of allocation may occur in row order, i.e., allocating row 0 first, row 1 next, and so on, but since recovery of rows in the table 400 is dependent on dynamic application properties, rows may be recovered for reuse in any order. It is therefore necessary to maintain a pool of indexes 410 into the table that indicates rows that are not in use and that map to appropriate rows of the table 400.

The presence of an index 410 in a pool of indexes indicates that the row is not currently in use. A network processor, for instance, using table 400 would obtain a row to house the state of a new connection by removing an index from the pool of indexes and mapping the index to a row; when the connection terminates, the network processor would return the index to the pool. The pool of indexes 410 can be stored as the data values in the hardware queue 220. This allows a network processor to retrieve or replace indexes 410 in a fast manner. In this example, the resources being allocated or recovered are the rows of the table 400 and the rows of the table are accessed using the indexes.

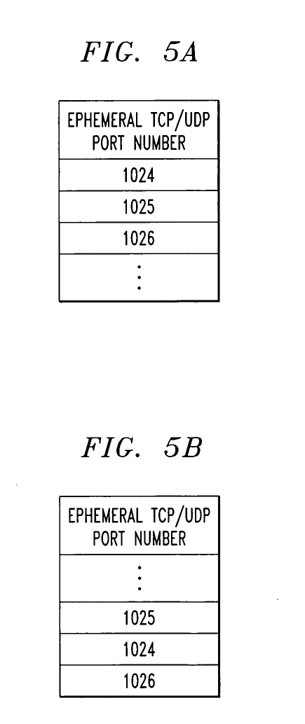

FIG. 5A is an exemplary table for mapping integers to ephemeral TCP or UDP ports for Network Address Port Translation (NAPT), and FIG. 5B is the exemplary table of FIG. 5A shown after TCP/UDP ports have been recovered in FIFO order. Each of FIGS. 5A and 5B shows a sequence of integers used as a pool of ephemeral port numbers for NAPT, a network processing application that must allocate, recover, and reuse unique ports having values within a predefined range. See, for instance, “Traditional IP Network Address Translator (Traditional NAT),” Internet Engineering Task Force and the Internet Engineering Steering Group (IETF), Request for Comments (RFC) 3022 (2001); “Architectural Implications of NAT,” IETF, RFC 2993 (2000); and “IP Network Address Translator (NAT) Terminology and Considerations,” IETF, RFC 2663 (1999), the disclosures of which are hereby incorporated by reference. The integers (corresponding to ports) shown in FIGS. 5A and 5B can be stored in the hardware queue 220 and can be used to map an integer to a port.

A NAPT application initializes the table shown in FIG. 5A in a simple ascending sequence within the range of values for the ports, but as the NAPT application uses integers from the table and later returns them to the pool of port numbers, the NAPT application can return them in any order. The table shown in FIG. 5B is the table of FIG. 5A after allocation of ports 1024, 1025 and 1026, followed by return of 1025, 1024, and 1026 into the pool in that order. All ports in the remaining range (indicated by “ . . . ” in FIG. 5B) will typically be allocated in future allocation requests before these recovered ports of 1025, 1024, and 1026. In the example of FIGS. 5A and 5B, the resource being managed is a TCP or UDP port and NAPT uses the integers corresponding to the ports when performing NAPT so that applications can access the ports.

Application constraints on NAPT make it desirable to reuse ports in the FIFO order illustrated in the tables shown in FIGS. 5A and 5B. When a port is returned to the pool of ports in the hardware queue 220 after the TCP or UDP connection to which the port corresponds is dropped, all ports ahead of this port in the pool should be allocated before this port is reallocated. This FIFO reuse strategy for resources is appropriate for any resource whose recovery is associated with a timeout, since FIFO order ensures that recovered resources will reside in the pool for the maximal time before being reused, avoiding “collision” of identical numbers (e.g., same port number used for different TCP or UDP connections) in close temporal proximity to the timeout instant.

Some applications of resource pools do not require FIFO reuse order. For example, allocation and recovery can occur in random order for unique “hardware thread IDs” used to index local storage for a temporary storage (e.g., in memory 210) for a hardware thread 206 in a multithreaded processor. The local storage is the resource being managed, and the local storage corresponds to a hardware thread ID stored in the hardware queue 220 and used to map to the local storage. The hardware thread IDs are used to access local storage. The hardware thread IDs are not associated with a timeout, and the order of allocation of the hardware thread IDs is irrelevant to their application. However, FIFO management of these resources does not cause problems for such applications.

Finally, some applications of integer resource pools may benefit from LIFO (last-in, first-out) reuse of integer identifiers for resources, primarily when a resource is allocated prematurely and is not actually used by an application; the integer identifier could then be reused immediately. Nonetheless, such applications are typically not harmed by FIFO reuse of such resources. In consequence, because of the apparent universality of FIFO applicability, and the ready availability of inexpensive hardware FIFO technology, the hardware queue 220 will typically be a hardware FIFO device. LIFOs and double-ended queues that allow insertion and extraction at either end of the memory of a queue could provide additional options for applications needing LIFO or double-ended queue functionality.

Moreover, the applications presented above are only some typical applications for managing resources using hardware queues. For instance, there are at least dozens of algorithms in network processing similar to NAPT, such as intrusion detection, firewalls, load balancers and content-switched routers, that could use certain embodiments of the present invention. Furthermore, there are other protocols besides TCP or UDP, such as HyperText Transfer Protocol (HTTP), that could use certain embodiments of present invention. Additional examples of the data values used in a hardware queue 220 for resource management are as follows:

(1) Indexes into a region of memory or an array of data structures in memory or other storage devices.

(2) Connection identifiers in a network protocol such as TCP/IP, UDP/IP or Asynchronous Transfer Mode (ATM). The examples given above of TCP or UDP ports are special cases of a connection identifier.

(3) Database keys to application data associated with the key. For instance, any time someone is handed an identification (ID), such as a social security number, an employee number, a customer number, an ID is an initially arbitrary number that, from that point on (i.e., until the ID is deallocated), the person can use in order to access associated data with the ID. In this example, both the ID and the associated data are the resources being managed. The data values stored in the hardware queue can similarly be used as the IDs for allocating and deallocating portions of the database or access to the database.

(4) Hardware IDs for dedicated hardware, particularly in an embedded system. Suppose an embedded system has three video surveillance cameras numbered 0, 1 and 2, and an application needs to point and monitor any one of these cameras. The hardware queue 220 could be initialized with the data values {0, 1, 2}, corresponding to “cameras requiring surveillance.” The application allocates and attaches to a video camera by allocating an appropriate hardware ID from the hardware queue 220.

It should be noted that examples (1), (2) and (4) above may also be considered an example of (3). For instance, integers corresponding to the hardware IDs of (4) could be the database keys of (3) and the hardware IDs of (4) could be the application data of (3).

FIG. 6 shows an exemplary circular buffer implementation and internal memory for a hardware FIFO 600, which can be used as a hardware queue 220. The implementation shown in FIG. 6 may be used for both software and hardware FIFOs. See the references already incorporated by reference and also Aho, Hopcroft and Ullman, “Data Structures and Algorithms,” Section 2.4: “Queues,” Addison-Wesley (1983), the disclosure of which is hereby incorporated by reference.

Hardware FIFO 600 comprises a queue process 630 that performs read and write operations to the queue memory 613, a read pointer 605, a write pointer 610, an element counter 620, and the queue memory 613 comprising N locations 615-1 through 615-N.

Each location 615-1 through 615-N in the queue memory 613 is suitable for storing a data value, e.g., a resource-identifying integer, such as an index into a state table or an ephemeral TCP port number. The read pointer 605, write pointer 610 and the element counter 620 could reside in registers or queue memory 613. The read pointer 605 points to the next element to be read in FIFO order (e.g., the “head” of the queue), and the write pointer 610 points to the next element to be written in FIFO order (e.g., the “tail” of the queue). The element counter 620 helps to distinguish between an empty and a full FIFO, as the read pointer 605 and write pointer 610 are identical in both the full and empty cases. Other implementations of FIFOs use one-bit empty and full flags in place of the element counter 620, and this is especially true of hardware FIFOs.

The following pseudocode gives the logic of the read operation for a hardware FIFO 600:

```
If (element_count equals 0) {
      Assert an “empty” error flag
} else {
      Set result = location of read_pointer
      Increment read_pointer
      If (read_pointer >= N) /* i.e., if the pointer goes past the end
      of table */
            Set read_pointer = 0
      Decrement element count
      Return result to the caller
}
```

The following pseudocode gives the logic of the write operation for the hardware FIFO 600:

```
If (element count equals N) { /* i.e., the table is full */
      Assert a “full” error flag
} else {
      Set location of write_pointer = value provided by application
            /* i.e., value being returned to the pool */
      Increment write_pointer
      If (write_pointer >= N)
            /* i.e., if the write pointer goes past the end of the table */
            Set write_pointer = 0
      Increment element_count
}
```

FIFO resource pools and resources pools in general are usually maintained in software. Consider a software implementation of FIG. 6 on a non-multithreaded or multithreaded processor. Each pseudocode function above executes one or more processor instructions for each line of code, or at least eight machine instructions for reading or writing. Typically some source-level instructions expand to multiple machine instructions, and these machine instructions may take multiple instruction cycles to execute, especially when fetching or storing to main memory 210. The cost is at least an order of magnitude more delay than the time to access a hardware FIFO, as the time to access a typical hardware FIFO can easily occur within one instruction cycle (i.e., as one fetch from the hardware FIFO or store to the hardware FIFO).

Exemplary advantages of the present invention are potentially the highest for multithreaded processors that do not provide hardware mutexes, and most multithreaded processors are of this type. Even for processors that do provide mutexes, there are speed and temporal determinacy advantages in avoiding the stalls that come with use of the mutex by using the typically single instruction access of a hardware queue of the present invention. Moreover, even non-multithreaded processors can benefit from the present invention, as speed for accessing the hardware queue to read or write data values, and therefore allocate or recover resources, is very fast as compared to resource management implemented in software.

For some applications, resource management is entirely provided by the hardware queue. For example, when rows of tables are being managed and the table is already allocated, then writing integers (e.g., corresponding to rows of the table) to or reading integers from the hardware queue deallocates or allocates, respectively, the rows. In other applications, additional steps might be taken in order to manage the resource. For instance, a port might need to be “opened.”

It is to be understood that the embodiments and variations shown and described herein are merely illustrative of the principles of this invention and that various modifications may be implemented by those skilled in the art without departing from the scope and spirit of the invention. For example, although data values stored in a hardware queue are typically the same number of bits, this is not necessary. Thus, a data value of zero could use less bits than a data value of 128 or more. Also, although only one hardware queue is shown in the exemplary embodiments, multiple hardware queues 220 could be used. Illustratively, FIFOs can be coupled together to provide a larger FIFO memory, either in width (e.g., number of bits per data value) or depth (e.g., number of data values able to be stored). In addition, separate hardware queues could be used to manage different resource pools. Each such hardware queue may, for example, have its hardware interfaces connected as shown for the single hardware queue.

1. A method for resource management in a processor-based system, the method comprising the steps of:
storing a plurality of data values in a hardware queue, each data value being associated with a corresponding one of a plurality of resources, wherein presence of a given one of the data values in the hardware queue indicates availability of its corresponding resource to a requesting object; and
utilizing the given data value from the hardware queue to access the corresponding resource.

2. The method of claim 1, further comprising the step of reading the given data value from the hardware queue.

3. The method of claim 2, wherein the step of reading at least partially allocates the given resource by removing the given data value from the plurality of data values in the hardware queue, thereby providing access to the corresponding resource by the requesting object of a plurality of objects in the processor-based system and preventing access to the corresponding resource for other objects in the processor-based system.

4. The method of claim 2, further comprising, in conjunction with the step of reading, the step of the hardware queue removing the given data value from the plurality of data values.

5. The method of claim 1, further comprising the step of writing the given data value to the hardware queue.

6. The method of claim 5, wherein the step of writing at least partially recovers the corresponding resource by adding the given data value to the plurality of data values in the hardware queue, thereby providing access to the given data value and its corresponding resource for any object of a plurality of objects in the processor-based system.

7. The method of claim 5, further comprising, in conjunction with the step of writing, the step of the hardware queue adding the given data value to the plurality of data values.

8. The method of claim 1, wherein each of the plurality of data values comprises a bit pattern uniquely corresponding to one of the resources.

9. The method of claim 1, wherein:
the hardware queue is accessed through a data bus;
the hardware queue comprises a queue memory and read and write interfaces;
the read interface reads from the queue memory and the write interface writes to the queue memory;
both the read and write interfaces are coupled to the data bus; and
the queue memory is configured to store the plurality of data values.

10. The method of claim 1, wherein the step of utilizing further comprises the step of mapping the given data value to its corresponding resource.

11. The method of claim 10, wherein each of the plurality of data values comprises a database key that corresponds to a portion of application data, and wherein the step of mapping further comprises the step of mapping the given data value to a corresponding portion of the application data.

12. The method of claim 11, wherein each of the database keys comprises an index, the application data comprises hardware identifiers and wherein the step of mapping further comprises the step of mapping the given data value to a corresponding hardware identifier.

13. The method of claim 11, wherein:
each of the database keys comprises an integer;
the application data comprises connection identifiers; and
the step of mapping further comprises the step of mapping the given data value to a corresponding connection identifier.

14. The method of claim 11, wherein:
the method further comprises the step of allocating a plurality of portions of a connection status table;
each of the database keys comprises an index identifying a portion of a connection status table; and
the step of mapping further comprises the step of mapping the given data value to a portion of the connection status table.

15. The method of claim 11, wherein:
each of the database keys comprises an integer corresponding to a hardware thread identification; and
the step of mapping further comprises the step of mapping the given data value to a local storage memory location corresponding to the hardware thread identification.

16. The method of claim 11, wherein:
each of the database keys comprises an index identifying an address range of a memory; and
the step of mapping further comprises the step of mapping the given data value to a given address range of the memory.

17. The method of claim 1, further comprising the steps of:
reading the hardware queue a plurality of times to retrieve a plurality of read data values from the plurality of data values;
writing the plurality of read data values to a predetermined portion of a memory; and
reading at least one of the read data values from the predetermined portion of the memory.

18. The method of claim 1, further comprising the steps of:
writing a plurality of written data values to a predetermined portion of a memory;
reading at least one of the written data values from the predetermined portion of the memory; and
writing the at least one written data value to the hardware queue to add the written data value to the plurality of data values.

19. An apparatus for resource management, the apparatus comprising:
a data bus;
a hardware queue coupled to the data bus, the hardware queue configurable to store a plurality of data values; and
one or more processors coupled to the data bus, the one or more processors adapted:
to store a plurality of data values in the hardware queue, each data value being associated with a corresponding one of a plurality of resources, wherein presence of a given one of the data values in the hardware queue indicates availability of its corresponding resource to a requesting object; and
to utilize the given data value from the hardware queue to access the corresponding resource.

20. The apparatus of claim 19, wherein the hardware queue comprises a queue memory and read and write interfaces, wherein the read interface reads from the queue memory and the write interface writes to the queue memory, wherein both the read and write interfaces are coupled to the data bus, and wherein the queue memory is configured to store the plurality of data values.

21. An integrated circuit comprising:
at least one hardware queue connectable to one or more processors via a data bus, the at least one hardware queue configurable to store a plurality of data values; and
the one or more processors adapted, for the at least one hardware queue:
to store a plurality of data values in the at least one hardware queue, each data value being associated with a corresponding one of a plurality of resources, wherein presence of a given one of the data values in the at least one hardware queue indicates availability of its corresponding resource to a requesting object; and
to utilize the given data value from the at least one hardware queue to access the corresponding resource.

22. The integrated circuit of claim 21, wherein the at least one hardware queue comprises a plurality of hardware queues, each of the plurality of hardware queues being associated with a given set of resources of a plurality of sets of resources.

23. The integrated circuit of claim 21, wherein the one or more processors are adapted to read the given data value from the at least one hardware queue during a read operation, wherein the hardware queue is adapted, in conjunction with the read operation, to remove the given data value from the plurality of data values, thereby providing access to the corresponding resource by the requesting object of a plurality of objects and preventing access to the corresponding resource for other objects.

24. The integrated circuit of claim 21, wherein the one or more processors are adapted to write the given data value to the at least one hardware queue during a read operation, wherein the at least one hardware queue is adapted, in conjunction with the write operation, to add the given data value to the plurality of data values, thereby providing access to the corresponding resource by providing access to the given data value.

25. The integrated circuit of claim 21, wherein the one or more processors are further adapted, in conjunction with utilizing the given data value, to map the given data value to its corresponding resource.

26. An integrated circuit comprising:
a data bus;
at least one processor coupled to the data bus;
at least one hardware queue coupled to the data bus, the at least one hardware queue comprising:
a queue memory configurable to store a plurality of data values;
a read interface coupled to the data bus and adapted to read from the queue memory; and
a write interface coupled to the data bus and adapted to write to the queue memory.

27. The integrated circuit of claim 26, wherein the at least one hardware queue is adapted to remove, in conjunction with a read operation, a given data value from the plurality of data values so that the given data value can no longer be read from the plurality of data values, and wherein the at least one hardware queue is adapted to add, in conjunction with a write operation, a given data value to the plurality of data values so that the given data value is accessible from the plurality of data values.

28. The integrated circuit of claim 26, wherein the at least one processor is adapted:
to store the plurality of data values in the at least one hardware queue, each data value being associated with a corresponding one of a plurality of resources, wherein presence of a given one of the data values in the at least one hardware queue indicates availability of its corresponding resource to a requesting object; and
to utilize the given data value from the at least one hardware queue to access the corresponding resource.

29. The integrated circuit of claim 28, wherein the integrated circuit comprises the plurality of resources, the plurality of resources are external to the integrated circuit, or at least part of each resource of the plurality of resources resides on the integrated circuit.

30. The integrated circuit of claim 26, further comprising:
an address bus; and
at least one queue enable module coupled to the address bus and to the at least one hardware queue, the at least one queue enable module adapted to enable the at least one hardware queue when an address on the address bus corresponds to an address associated with the at least one hardware queue.
